(19) United States
(12) Patent Application Publication
(10) Pub. No.: US 2015/0254354 A1
(43) Pub. Date: Sep. 10, 2015

(54) COMPUTER METHOD, SYSTEM AND PRODUCT FOR PLAYLIST CONTROL USING MEDIA SPOTS HAVING INTELLIGENT CONTENT

(71) Applicant: JOHN RYAN PERFORMANCE, INC., Minneapolis, MN (US)

(72) Inventors: Gary Paul Madgwick, Lightwater (GB); Nancy Radermecher, Orono, MN (US)

(21) Appl. No.: 14/640,103

(22) Filed: Mar. 6, 2015

Related U.S. Application Data
(60) Provisional application No. 61/949,768, filed on Mar. 7, 2014.

(51) Int. Cl. G06F 17/30; G06Q 30/02

(52) U.S. Cl. CPC G06F 17/30864; G06Q 30/0259

(57) ABSTRACT

Systems, methods and/or computer program products provide a digital signage network with content controlling spots within a playlist that control retrieval, scheduling, delivery and playback of content stored remotely from the media spot.

### FIELD OF THE DISCLOSURE

Implementations are directed to digital signage networks adapted to play media content. More particularly, media spots within a playlist control content delivery of content stored remotely from the media spot.

### BACKGROUND

Conventional digital signage networks typically distribute media content within a playlist for playing on screens within a number of entities within the network. Typically, multiple copies of the same playlist are distributed across each of the network entities. Implementing changes to these playlists often requires time-consuming, manual edits of each playlist distributed. As a result, to avoid this requirement, many playlists transmit generalized content or outdated content.

### SUMMARY

A computer-implemented method, system and/or computer program product that uses an existing system's playlist and playback to embed a content controlling spot. One or more electronic databases store a playlist with a content controlling spot therein. The content controlling spot is a spot adapted to execute instructions for retrieving media files stored remotely or locally for its use. The content controlling spot then controls the playback of the media. After it has finished, the content controlling spot hands back control to the host system and the host system's playlist continues.

Certain implementations may include a method of playing media spots on digital signage from a playlist with a plurality of spots, including a content controlling spot (CCS). The method may involve iterating through the playlist. The iteration may include determining a next spot of the playlist and, responsive to determining that the next spot is the CCS, passing content playback control to the CCS by instigating the CCS and taking content playback control back from the CCS in response to determining that the CCS has completed operation. The operation of the CCS, may include querying a data file to retrieve search data; determining, using the CCS, one or more matching spots of a plurality of media spots based on the search data; and playing at least one of the one or more matching spots on the digital signage.

Certain implementations may include a digital signage network entity for playing media content having a processor operably coupled to a display and a memory. The memory may contain a playlist with instructions. The instructions may, when executed, cause the processor to: determine a next spot of a sequence; play the next spot; instigate a content controlling spot (CCS) by executing content controlling spot instructions responsive to determining that the next spot is the CCS; and take command of playback responsive to determining that the content controlling spot instructions have completed. The content controlling spot instructions may include instructions that, when executed, cause the processor to: query a data file to retrieve search data; determine one or more matching spots of a plurality of media spots based on the search data; play at least one of the one or more matching spots on the display; and return playback control in response to determining the completion of operations.

Certain implementations may include a plurality of digital signage network entities and a digital signage network site communicatively coupled with the digital signage network entities.

Each of the digital signage network entities may comprise: a processor operably coupled to a display and a memory. The memory may include a playlist with instructions. The instructions may, when executed, cause the processor to: determine a next spot of a sequence; play the next spot; instigate a content controlling spot (CCS) by executing content controlling spot instructions, responsive to determining that the next spot is the CCS; and take command of playback responsive to determining that the content controlling spot instructions have completed. The content controlling spot instructions may include instructions that, when executed, cause the processor to: query a data file to retrieve search data; determine one or more matching spots of a plurality of media spots based on the search data; play at least one of the one or more matching spots on the display; and return playback control in response to determining the completion of operations.

The digital signage network site may include a network site processor and a network site media. The network site media may include instructions that cause the network site processor to perform one or more of the following on the playlist of the memory of at least one of the plurality of digital signage network entities: generate, retrieve, edit, validate, store, distribute, and play.

### BRIEF DESCRIPTION OF THE DRAWINGS

FIG. 1 is a block diagram of a digital signage network according to certain implementations.

FIG. 2 illustrates a method of using controlling content spots (“CCSs”) within a playlist control content delivery of content stored remotely from the playlist.

FIG. 3 illustrates a method of using the digital signage network in which media spots are played within playlists containing CCSs.

### DETAILED DESCRIPTION

Overview

Implementations provide systems, methods and computer program products for providing digital signage networks adapted to include playlist spots configured to control content delivery of content stored remotely from the playlist spot.

Digital signage networks typically include a plurality of network locations that are geographically separate. The network location, for example, may be a branch of a service provider (e.g., a bank) or retail location (e.g., a department store). A network entity within the network location may be a media player configured to play spots within playlists according to a schedule. Each network location may include one or more network entities. The implementations of the present disclosure offer the ability to insert a content controlling spot (“CCS”) within a media slot (also referred to as “slots”) in a playlist, or in playlists of any kind, and the CCS includes intelligent content that enables the CCS to command control of delivery of media content stored remotely from the CCS. This enables the CCS to be inserted into any playlist and media content from disparate locations may be retrieved and played by the CCS or by a media player to which the CCS directs the media content.

A CCS with its intelligent content is differentiated from a media content spot (“MCS”) containing video and audio content delivered to a media player for playback. Typically, the CCS controls delivery and playback of MCSs. In some implementations, the intelligent content of the CCS includes the ability to dynamically control MCSs delivered to players based on attributes associated with the MCSs and the CCSs may serve as placeholders, which can be dynamically populated. By associating a collection of attributes to MCSs, the MCSs may be played in a variety of CCSs stored within multiple playlists across multiple media players, as described further below.

In certain implementations, digital signage may be digital display devices or systems used to present information to a targeted audience. Examples of digital signage according to these implementations may include but are not limited to: electronic billboards, digital signage kiosks, mounted screens, and other display devices. Digital signage may also include systems or devices that fall under the category of out of home advertising. Digital signage may present a variety of content to viewers, including but not limited to flight status information, bus status information, train status information, advertising, wait time status information, menu information, daily specials information, content to attract customers, call center information, patient information, and other content.

In certain implementations, the digital signage is not a generic consumer computer and may instead be a special display apparatus communicatively coupled to a content player. For example, the digital signage may utilize an embedded system. In this manner, the digital signage may require or consume fewer resources than a consumer electronics system.

In certain implementations, digital signage may be networked to receive content remotely (e.g. remotely from a user directing content playback). For example, while the digital signage's display may be placed in a location with heavy customer traffic, a means for sending user input to the display may be located remotely from the display (e.g. in a back office, in another room of the same building, or located within another building). As another example, a plurality of digital signage may be remotely controlled by a control system remotely located from the plurality of digital signage (e.g. in another building).

### DESCRIPTION OF THE EMBODIMENTS

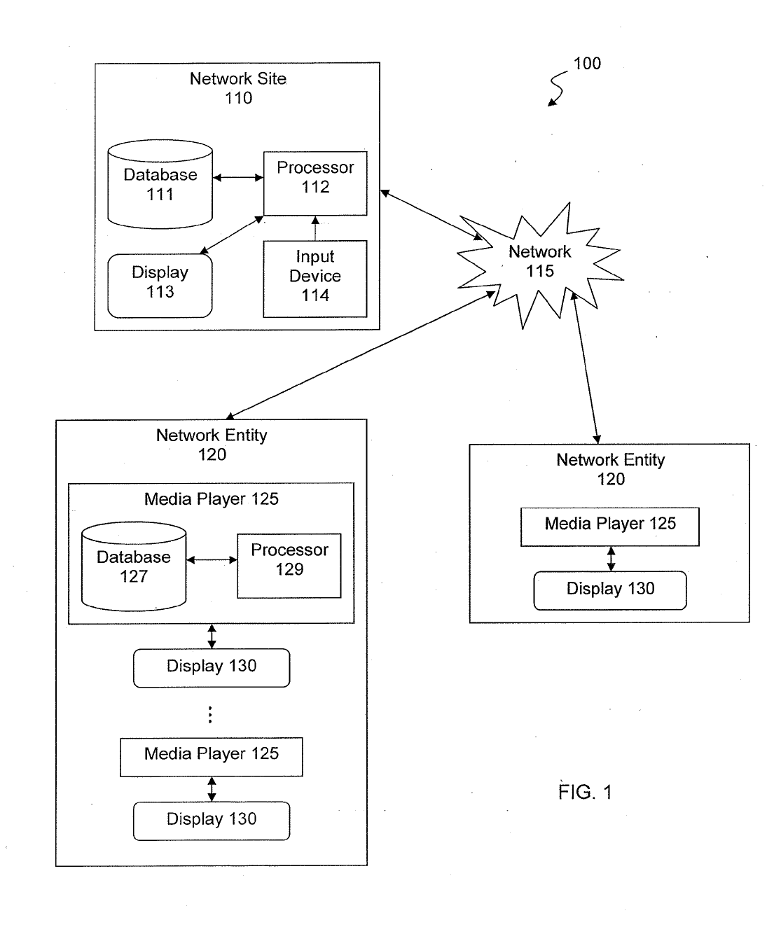

FIG. 1 is a block diagram of a digital signage network 100 according to certain implementations. The digital signage network includes a network site 110 with a database 111, a processor 112, an input device 113 and a display 114. The network origination site 110 may be one or more general purpose computers, special purpose computers or both. The network site 110 may include one or more media players described below.

The database 111 may store:

Playlists (e.g., a sequence of media to be played or slots for being linked to media to be played on selected screens at selected sites based on a schedule).

Media slots for inserting into playlists including slots with filters and schedules.

Controlling content spots (“CCS”) (e.g., a spot including intelligent content for querying content external to the playlist and directing play of the external content via the CCS or via a player).

Media content spots (“MCS”) (e.g., an assembly of media within additional text, data or pictures) that may include spots with attributes.

Media (e.g., .jpg, .mov files and .swf files, including files that do not incorporate additional movie, picture, text or data files).

Filters (e.g., an attribute-based query or rule, attributes may be combined within the filter through Boolean logic operators).

Attributes (e.g. characteristics assigned to slots and spots such as secondary language spoken, regional affiliation, state, primary segment served or neighborhood type).

Attribute values (a subset or type of attribute attached to attributes such as German, Spanish, or Chinese for the secondary language attribute; urban or rural for the regional affiliation; Minnesota or New York for the state attribute; senior citizens, youth, Hispanic, males between 18-40 for the primary segment served attribute; and street front, mall, in-store for the neighborhood type attribute).

Schedules (e.g., a defined list of times to which playlists are assigned typically using time, date, day of the week criteria).

The processor 112 of the network site 110 executes instructions for generating, retrieving, editing, validating, storing, distributing, and playing playlists including playlists with CCS stored therein. The processor 112 may also execute instructions common to digital signage networks including but not limited to generating, retrieving, editing, storing and distributing media, spots, traditional playlists with predefined media assigned thereto, schedules.

The input device 113 and display 114 may be adapted to enable a user to provide input for executing the processor 112 instructions including but not limited to creating user-specific content, scheduling and targeting templates that link directly to a CCS in a playlist, adding filters, attributes and attribute values to CCSs and adding attributes and attribute values to MCSs.

A network 115 is communicatively coupled to and adapted to receive and distribute content between the network site 110 and the network entities 120. The network 115 may be formed of communication means including but not limited to an Internet protocol network, a satellite linked network, intranet, wide area network and combinations thereof.

The network entities 120 may be geographically separate from one another, such as residing at a service provider or retail location, and includes a computer system (e.g., with a memory, processor and optionally an input device and display). The network entities 120 are communicatively coupled to and support at least one media player 125 but typically network entities 120 support multiple media players 125. In some implementations, the network entities 120 may include firewalls and other security modules that regulate information into and out of the network entity 120. In some implementations, the network entities 120 may be adapted to execute instructions associated with the network site 110 discussed above. For example, using the computer system of the network entity 120, spots and playlists may be edited and sent to media players 125 associated with the network entity 120.

In FIG. 1, the media players 125 include a memory 127 and a processor 129 and are communicatively coupled to a display monitor 130. The memory 127 is adapted to store the schedules, playlists, CCSs, MCSs and channel information (e.g., a programming stream having playlists assigned thereto, such as a teller channel located proximate a bank teller's location or an ATM channel located proximate an ATM machine). The processor 129 is programmed to retrieve from the memory 127 the playlists based on the schedules and execute instructions according to the intelligent content provided in the CCSs for playing MCSs.

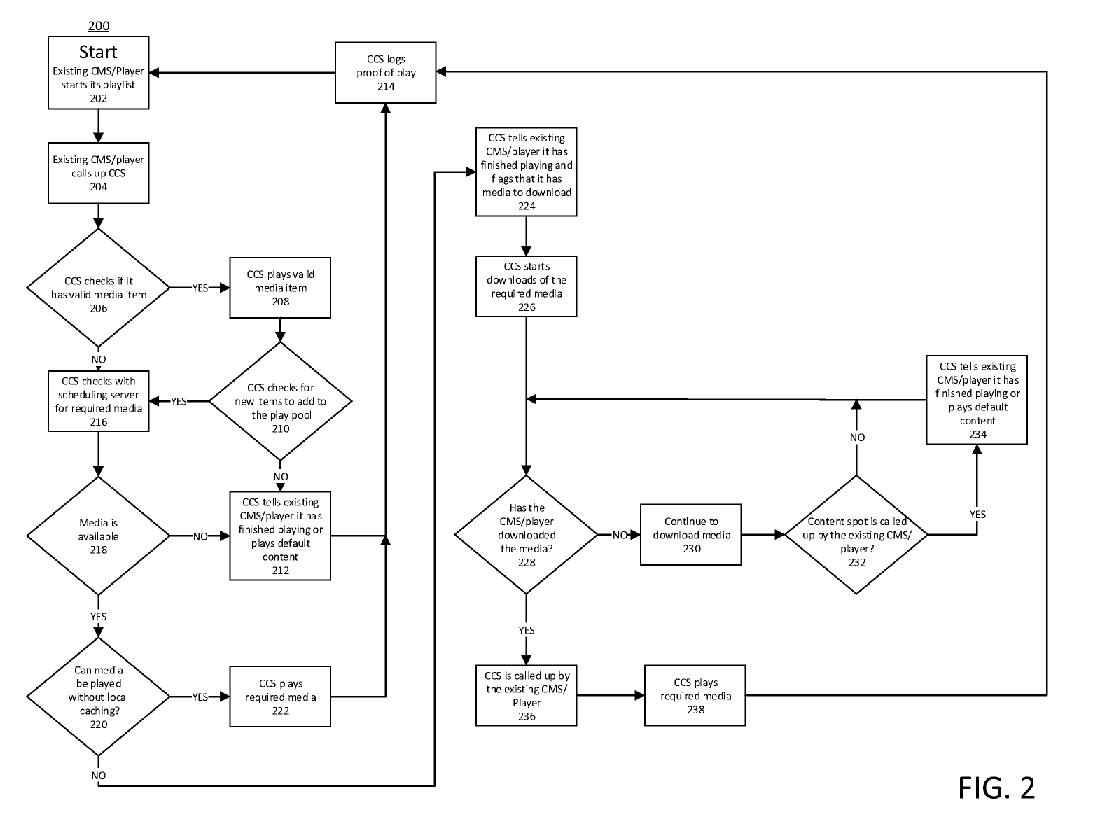

FIG. 2 illustrates a method 200 of using the digital signage network 100 in which a controlling content spot (“CCS”) within a playlist controls retrieval and playback of content stored locally or remotely from the playlist. The method starts at the top left of FIG. 2 where a content management system or player starts 202 a playlist. The playlist includes a CCS. Generally, the CCS is distributed to one or multiple playlists in a manner typical to delivery of spots or content to playlists. For example, the content management system (“CMS”) sends the CCS to a playlist generally, or to a slot within a playlist. In one approach, users may login to a CMS website and download one or more CCSs into playlists, e.g., local, regional and/or network-wide playlists.

The method of FIG. 2 continues when the CMS/player calls 204 the CCS in the playlist. The CCS intelligent content is initiated and the CCS determines 206 if the CCS itself includes a valid media item. The valid media item may be a MCS situated locally that may be a scheduled MCS or may be a default MCS. If the CCS includes the valid media item, the CCS plays 208 the media item and determines 210 if any new items are to be added to the CCS's possible play pool. If not, the CCS notifies 212 the CMS/player that the media item has finished playing it. In certain implementations, the CCS checks 212 for any other media items that may be candidates for playback by the CSS, and initiates a retrieval process before telling the CMS/player it has finished playback. The CSS may log 214 proof of play (e.g., this may be used for invoicing spots per use or general invoicing) and the process of FIG. 2 may start again.

Otherwise, if the CCS determines 206 new items are to be added to the CCS' play pool, the CCS queries 216 a scheduling server for required media. This step in the flow is also reached when the CCS does not include a valid media item. That is, when the CCS determines that it does not have a valid media item or when the CCS determines 210 new items are to be added to the CCS play pools, the flow continues to the step where the CCS queries 216 a scheduling server for required media. If media is not available from the scheduling server 218, default media may be played 212. For example, the default media may be a MCS stored locally at a player. When the default media has been played, the CCS notifies 212 the CMS/player that the media item has finished playing, may log 214 proof of play and the process flow of FIG. 2 may start again.

Where media is available from the scheduling server 218, the flow continues and the CCS determines 220 whether the media can be played without local caching. If so, the CCS plays 222 the media and the CCS may log 214 proof of play and the process flow of FIG. 2 may start again.

If the CCS determines 220 local caching is required, the flow continues by the CCS notifying 224 the CMS/player it has finished playing and flags that the CMS/player has media to download. The CCS then initiates 226 the download of the required media. The flow may proceed by the CCS determining 228 whether the CMS/player has downloaded the media, and if downloading is not complete, the CCS may continue 230 the download and query 232 whether a content spot (e.g., MCS) or other default spot has been called up by the CMS/player. If so, the CCS notifies 234 the CMS/player the content spot has finished playing or plays 234 default content and continues to re-check 228 whether the media is downloaded. Where the content spot has not played, the CCS continues to check 228 whether the media is downloaded. When downloading is complete, it is ready for playback when the CMS/player next initiates. The CCS with the required downloaded content is called up 236 by the CMS/player and the required media is played 238. The CCS may log 214 proof of play and the process flow of FIG. 2 may start again. Thus, the process 200 of FIG. 2 is implemented in a loop, but this process 200 is not limited to the looping operations shown and may loop at other points or may terminate at various points in the process 200 according to the present disclosure.

According to one implementation, once the CCS is called up in the playlist, the CCS queries a local or remote data file (e.g., an XML file or web service) to determine the content to be played and manage its delivery and playback. As the CCS reads the data file it determines the content the CCS should play and the CCS either plays the content if the CCS is able to play such content, or the CCS downloads the content to a location from which the CCS is able to control play of the content, and the CCS commands play of such content. The content played by the CCS may be a MCS or multiple MCSs. In some implementations the CCS may implement conditional playback logic based on identifying MCSs with attributes and values required by the data file.

The CCS provides advantages to prior approaches because a host system does not require the intelligent content stored within the CCS, but only requires that the host system contain the CCS itself. In addition, the CCS itself controls a portion of a playlist where the CCS is inserted. With this capability, playlists may otherwise remain unchanged, which may benefit systems that are otherwise difficult to modify. In a particular example, where the CCS is called up in a playlist, the CCS may command replacement of any or all of the content within the playlist using one or more MCSs identified from execution of the intelligent content of the CCS.

According to certain implementations, CCSs may dynamically command play of any of a number of spots based on the CCS intelligent content including filters, attributes, attribute values, linked data files, database references, URLs and combinations thereof. The CCS intelligent content may form a bridge between a respective CCS and a collection of MCSs. In some approaches, the MCSs may include respective spot filters, attributes and/or attribute values, linked data files, database references, URLs and combinations thereof. Where a MCS includes a number of bridging associations, CCSs having with any of these associations may command play of the media spot. In addition, where a CCS includes a number of bridging associations, the CCS may command play of MCSs having any corresponding association.

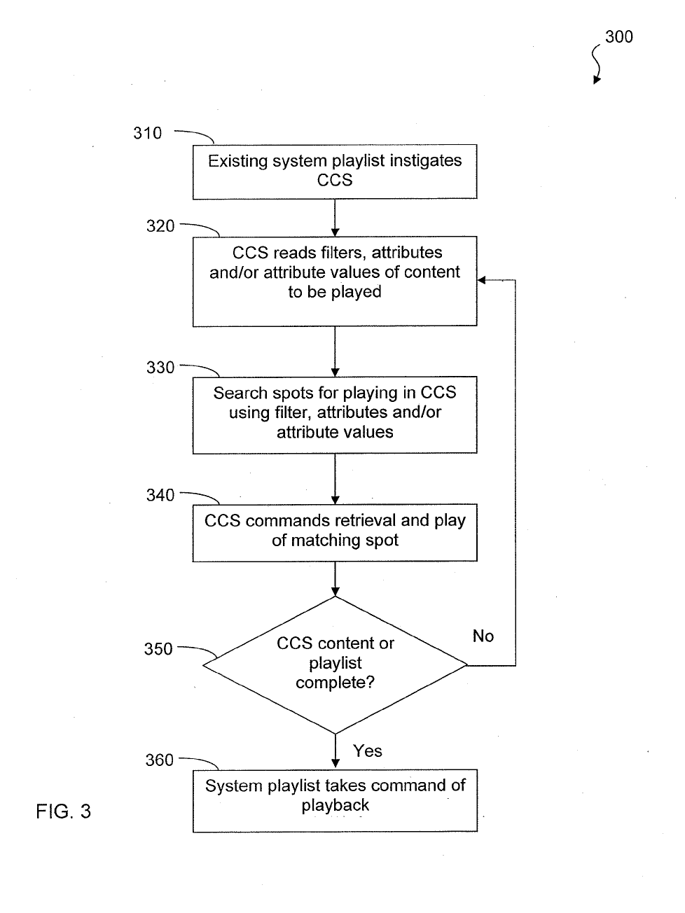

FIG. 3 illustrates a method 300 of using the digital signage network 100 in which media spots (e.g., MCSs) are played within playlists containing CCSs. In operation 310, an existing system playlist instigates a CCS. In some cases the system may instigate the CCS upon initiation of a playlist, while in other cases, the system may call up the CCS at some point during operation of the playlist. The CCS may include a data file or may query a data file containing a filter, attributes and attribute values or a database or a URL or a file reference, in operation 320. The filter, attributes and/or attribute values and/or a database or a URL or file references may be used by the CCS to search for a spot to play within the playlist in operation 330.

Because media spots may be stored separately from playlists containing the CCSs, the CCS may instruct the processor 129 to use the filter and attribute information when searching for spots stored in the memory 127, or elsewhere, having coinciding or matching spot attributes and attribute values. In addition or alternatively, the CCS may link to a media file with filter and attribute information used to locate spots. In addition or alternatively, the CCS may link directly to a media file, to database references associated with media files, and/or to URLs associated with media files. Separately storing the playlists with CCSs from the spots enables a single copy of a spot to be retrieved and be played in multiple playlists. Accordingly, in the present disclosure, the CCSs and the spots operate independently of one another, e.g., the two are separate entities, and are linked in circumstances where the spots and the CCSs share a common link, association or attribute. In a particular example, the CCS, or the data file queried according to the CCS intelligent content, may require a spot with a secondary language attribute and include Boolean attribute values of Spanish or French; and the processor 129, under direction of the CCS, identifies one or more spots having a secondary language attribute and an attribute value of Spanish as a coinciding spot in operation 320.

Continuing with the method of FIG. 3, upon locating a matching spot, the CCS instructs the processor to retrieve and play the matching spot in operation 340. For example, where the matching spot is stored within a local memory and caching is not required, the CCS may play the spot. Where the matching spot is remotely stored and requires caching, the CCS may retrieve and download the spot and play it. Where local caching is required, the CCS may play default content until the spot is downloaded or instruct the CMS/player to continue with its playlist. Where the matching spot is remotely stored and does not require caching, the CCS may play it.

Once the spot has been played, a determination is made as to whether the CCS content or playlist is complete in operation 350, and if not, the CCS continues to command retrieval and playback of content according to operations 320-340. When a determination is made that the CCS content or playlist is complete in operation 350, the system playlist takes command of playback of content in operation 360.

In further implementations, the CCS or the data file to which the CCS links identifies a schedule attribute and attempts to locate a spot with a corresponding schedule attribute. If the spot schedule coincides with the schedule of the CCS, the CCS instructs that the spot be retrieved and played. However, where a search of a spot with the requisite scheduling attributes is not located during the search, the CCS may skip the media slot such that content is not transmitted from the CCS within the playlist. The flow may then move to the next media slot and play media stored therein, or where the slot includes a CCS, may perform operations 320, 330 and 340.

Method 300 differs from traditional file naming and file matching operations used to execute playlists found in prior approaches because the filters or links associated with the CCSs within the playlists are adapted to allow any number of media spots to be played within the media slots, whereas the traditional file naming and matching operations target a single piece of media for playing within the playlist. Further, multiple attributes with their associated values may be assigned to CCSs or their associated data files and to media spots (e.g., MCSs). The attributes may be themed (e.g., secondary language, propensity to buy, geographic neighborhood type, primary segment served) and the attribute values may be linked by Boolean values including AND, OR and NOT. Attributes may be stored as metadata tags. Further, MCSs with their attributes differ from simple titles assigned to the media spots, because titles typically only serve as way for a user to identify the type of media content within the media spot, but the media player under the direction of the CCS does not play the media spot based on its title, but rather the spot is played in a playlist upon execution of the CCS when the spot's attributes match with the filter attributes of the CCS in the playlist or the data file or database or URL linking to the CCS.

In a particular example, one or more CCSs in the playlist or the data file linking to the CCSs may be assigned a Boolean filter in which the filter includes the attribute of “Language” and Boolean attribute values of “Spanish” OR “Greek.” The filter therefore allows media spots having the attribute of “Language” and an attribute value of one of “Spanish” or “Greek” to be played in the playlist.

In another example one or more CCSs in the playlist or the data file linking to the CCSs may be assigned a filter of “Propensity to buy,” an attribute of “Loans” and a value of “High.” The filter associated with the one or more CCSs in the playlist or the data file linking to the CCSs allows media spots to be played that have an attribute of “Propensity to buy loans” and a value of “High.” Alternatively, one or more CCSs in the playlist or the data file linking to the CCSs may be assigned a filter named “Propensity to buy,” an attribute of “Loans” OR “Mortgage,” each with an attribute value of “High.” In this example, the aforementioned spot will play due to the matching “Loans” attribute.

In yet another example, a CCS in a playlist may be targeted for messages appropriate to the dominant customer segment (e.g., senior citizens, young adults, etc.) for a given network entity. In order for a spot to play in the CCS, the spot attributes must be related to a segment-oriented message.

Media spots may be targeted to the CCS within the playlist using a process that is independent from the targeting and scheduling of the playlist as a whole. In other words, the CCSs, playlists and the spots may be independently managed, potentially by different users in the network 100. Upon building a playlist, the playlist may be delivered or retrieved by one or more network entities. Subsequent installation of CCSs within the playlist in one or more players at the network entity enables the CCSs to command control of a portion of the playlist.

The CCS may be accessible to users of the network and may be configured to enable the user to create content for delivery by the CCS, schedule spots, e.g., MCSs, and target templates that link to the CCS. The CCS modifications may be enabled by providing user-specific functionalities based on user type. The functionalities may include content creation for a spot, such as updating a background, changing a headline or picture, selecting among titles, entering a data feed; content management, such as scheduling the content (or portion thereof) and targeting it to sites by means of meta-tags and attributes; workflow, e.g., setting in motion emails and approvals appropriate to the task at hand. In one example, a CCS user interface may be generated by uploading a file that follows a schema that determines which functionalities will be made available to the user.

Furthermore, a central, master user may cede control over the offered functionality to an array of users. For example, one user role may have the authority to update a background, and another to re-write the headline. These users each have defined permissions within the underlying CMS and these permissions may be carried forward as they make use of the CCS custom user interface. For example, if a Minnesota regional manager is given authority to update, schedule and target a spot using one of these custom interfaces, his span of targeting control will automatically be restricted to the Minnesota region based on his permissions in the underlying CMS, even if he attempts to distribute his creation more broadly using the form's targeting component.

Accordingly, implementations of the present disclosure may provide CCS within playlists and the intelligent content within the CCS enable content remotely located from the CCS to be dynamically delivered to media players, and further provide the ability for users to create and target content to the CCS. In combination, this allows end users to overcome CMS management difficulties without making significant change to the CMS infrastructure.

Exemplary implementations provide a computer-implemented method, system and/or computer program product that delivers content using a playlist including a content controlling spot. One or more electronic databases stores a playlist with a content controlling spot therein. The content controlling spot is a spot adapted to execute instructions for retrieving media files stored remotely from the playlist and to transmit the media files for playback. The content controlling spot may identify the stored media files for playback based on matching media attributes of the content controlling spot with media attributes of one or more media files or database references or URLs or file reference associated with media files. In addition or alternatively, a data file linked to the content controlling spot may be used to identify the stored media files for playing based on matching media attributes of the content controlling spot with media attributes of one or more media files or of database references or URLs associated with the media files. In addition or alternatively, the content controlling spot or an associated data file may link directly to media files or to database references or URLs associated with media files. Once a matching media file is located, the content controlling spot provides instructions to retrieve and play the media file. In further exemplary embodiments, the content controlling spot instructs that the media file be downloaded from a remote location. The content controlling spot may further instruct that default content be played during such downloading. The content controlling spot may log play of the media file. According to further exemplary embodiments, the content controlling spot may include a filter with a media attribute for targeting a media file type to be retrieved and played. The media attribute may further include an attribute value for targeting a subset of the media file type targeted by the attribute. Media files, such as media content spots, may be adapted to be retrieved and played under direction of the content controlling spots by the files including a media attribute identifying a media file type, which may optionally be combined with an attribute value identifying a subset of the media file type. The content controlling spot and/or the media file may also be associated with a play schedule. In yet further exemplary embodiments, the content controlling spot functionalities may be modified by a user and may include functionalities such as content creation, content functionality and workflow.

The methods disclosed may be implemented as sets of instructions or software readable by a device. The specific order or hierarchy of steps in the disclosed methods are examples of sample approaches, and the specific order or hierarchy of steps in the method can be rearranged while remaining within the disclosed subject matter. The accompanying system, method and computer-readable media claims present elements of the various steps in a sample order, and are not necessarily meant to be limited to the specific order or hierarchy presented.

The present disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and its advantages will be understood by the foregoing description, and it will be apparent that changes may be made in the form, construction and arrangement of the components without departing from the disclosed subject matter. The form described is merely explanatory, and it is the intention of the following claims to encompass and include such changes.

While the present disclosure has been described with reference to various embodiments, it will be understood that these embodiments are illustrative and that the scope of the disclosure is not limited to them. These and other variations, modifications, additions, and improvements may fall within the scope of the disclosure as defined in the claims that follow.

What is claimed is:

1. A method of playing media spots on digital signage from a playlist comprising a plurality of spots, including a content controlling spot (CCS), the method comprising:
iterating through the playlist by:
determining a next spot of the playlist; and
responsive to determining that the next spot is the CCS:
passing content playback control to the CCS by instigating the CCS, wherein the CCS queries a data file to retrieve search data;
determining, using the CCS, one or more matching spots of a plurality of media spots based on the search data;
playing at least one of the one or more matching spots on the digital signage; and
taking content playback control back from the CCS in response to determining that the CCS has completed operation.

2. The method of claim 1, wherein the CCS comprises the data file.

3. The method of claim 1, wherein the search data comprises at least one attribute having a value.

4. The method of claim 3, wherein the at least one attribute is based on one or more of: secondary language, propensity to buy, geographic neighborhood type, or primary segment served.

5. The method of claim 1, wherein the search data comprises a filter.

6. The method of claim 5, wherein the filter is a Boolean filter comprising a plurality of attributes.

7. The method of claim 1, wherein the search data comprises one or more of: linked data files, database references or URLs.

8. The method of claim 1, wherein the at least one of the one or more matching spots is remotely located from the CCS.

9. The method of claim 8, wherein the at least one of the one or more matching spots is locally cached at the digital signage prior to playing.

10. The method of claim 1, wherein a plurality of matching spots are played prior to taking control back from the CCS.

11. The method of claim 1, wherein the CCS is remotely accessible and configured to enable a user to modify the CCS.

12. The method of claim 11, wherein the user has user-specific functionalities based on a user type.

13. The method of claim 1, further comprising logging a proof of play responsive to playing the at least one of the one or more matching spots.

14. A digital signage network entity for playing media content having a processor operably coupled to a display and a memory, the memory comprising:
a playlist comprising instructions that, when executed, cause the processor to:
determine a next spot of a sequence;
play the next spot;
instigate a content controlling spot (CCS) by executing content controlling spot instructions, responsive to determining that the next spot is the CCS; and
take command of playback responsive to determining that the content controlling spot instructions have completed,
wherein the content controlling spot instructions comprise instructions that, when executed, cause the processor to:
query a data file to retrieve search data;
determine one or more matching spots of a plurality of media spots based on the search data
play at least one of the one or more matching spots on the display; and
return playback control in response to determining the completion of operations.

15. The system of claim 14, wherein the content controlling spot instructions further comprise instructions that, when executed, cause the processor to log a proof of play.

16. The system of claim 14, wherein the data file is remote from the digital signage network entity.

17. The system of claim 14, wherein the at least one CCS is further configured to command replacement of at least one other of the plurality of spots.

18. The system of claim 14, wherein the at least one CCS is further configured to dynamically command play of any of a number of spots.

19. The system of claim 14, wherein the digital signage network entity is located at a service provider or a retail location.

20. A digital signage network comprising:
a plurality of digital signage network entities, each of the plurality of digital signage network entities comprising:
a playlist comprising instructions that, when executed, cause the processor to:
determine a next spot of a sequence;
play the next spot;
instigate a content controlling spot (CCS) by executing content controlling spot instructions, responsive to determining that the next spot is the CCS; and
take command of playback responsive to determining that the content controlling spot instructions have completed,
wherein the content controlling spot instructions comprise instructions that, when executed, cause the processor to:
query a data file to retrieve search data;
determine one or more matching spots of a plurality of media spots based on the search data;
play at least one of the one or more matching spots on the display; and
return playback control in response to determining the completion of operations;
a digital signage network site communicatively coupled with the digital signage network entities, the digital signage network site comprising a network site processor and a network site media comprising instructions that cause the network site processor to perform one or more of the following on the playlist of the memory of at least one of the plurality of digital signage network entities: generate, retrieve, edit, validate, store, distribute, and play.
